(19) United States
(12) Patent Application Publication
(10) Pub. No.: US 2011/0218710 A1
(43) Pub. Date: Sep. 8, 2011

(54) METHOD AND CONTROL DEVICE FOR TRIGGERING PASSENGER PROTECTION MEANS FOR A VEHICLE

(75) Inventors: Hoang Trinh, Stuttgart (DE); Werner Nitschke, Asperg (DE); Gunther Lang, Stuttgart (DE)

(73) Assignee: ROBERT BOSCH GMBH, Stuttgart (DE)

(21) Appl. No.: 12/737,508

(22) PCT Filed: May 25, 2009
(86) PCT No.: PCT/EP2009/056296

§ 371 Date: May 26, 2011

(30) Foreign Application Priority Data
Jul. 22, 2008 (DE) 10 2008 040 590.6

(51) Int. Cl. B60R 21/0136; B60R 21/0132

(52) U.S. Cl. 701/46; 701/45

(57) ABSTRACT

In a method for triggering a passenger protection arrangement for a vehicle, a crash type is detected with the aid of at least one structure-borne noise signal, and the triggering takes place as a function of the crash type. For the crash type recognition, the structure-borne noise signal is evaluated in a predefined time period with regard to a change in amplitude.

### BACKGROUND OF THE INVENTION

1. Field of the Invention

The present invention relates to a method and a control device for triggering passenger protection means for a vehicle.

2. Description of the Related Art

A device for impact detection via structure-borne noise in a vehicle is known from published German patent application document DE 102 45 780 A1, which is characterized in that the device generates structure-borne noise via at least one detector, which is transmitted to at least one vibration sensor for impact detection. The structure-borne noise signal that is characteristic of these detectors can be used to evaluate the crash type. For example, a crash with a deformable barrier or a non-deformable barrier may be inferred from it.

### BRIEF SUMMARY OF THE INVENTION

In contrast, the method according to the present invention and the control device according to the present invention for triggering passenger protection means for a vehicle have the advantage that now the crash type recognition with the aid of the structure-borne noise signal takes place in a predefined time period with regard to a change in amplitude. This invention is based on the idea that the different crash types differ with regard to their time response, in particular in the event of a frontal impact, such as a so-called AZT crash, an ODB crash, and a so-called bumper 8-km/h crash, for example. The so-called AZT (Allianz Center for Technology) crash is a hard crash, in the event of which passenger protection are not to be triggered, however. Yet the AZT crash has very large signals, larger than the signals in the so-called ODB (offset deformable barrier) crash, for example, in the event of which a triggering is certainly to take place, as a function of the impact speed. The provided method and the provided module for crash type recognition respectively constitute an additional function for crash type recognition. In the event of an AZT crash, the front structural elements, transverse members, and crash box are deformed relatively early, for example, 10 to 15 milliseconds after the start of impact, so that accordingly large signal amplitudes form in the process. After a short period of time, this amplitude drops sharply. In contrast, in the ODB crash, due to the stiffer vehicle front-end structure, predominantly the barrier is deformed, so that the transverse members, crash box, and longitudinal members exhibit little or no deformation in this early phase, and deformations, which in turn generate small structure-borne noise signals, occur only in a later phase, approximately 25 to 40 milliseconds after the start of the crash. In the case at hand, the term start of the crash is the contact instant between the parties to an accident. That is, the relative drop from the maximum amplitude of the structure-borne noise signal differs greatly in the AZT crash and in the OBD crash, so that this feature is used for crash type differentiation in the present invention. In the case of an AZT crash, the crash energy is completely absorbed by the deformation of the transverse members and the crash box, so that the structure-borne noise that formed dies down quickly after a strong build-up.

The triggering of the passenger protection means such as airbags, belt tighteners, crash-active headrests, seat elements, etc., means the activation of these passenger protection means.

The at least one structure-borne noise signal is output by a structure-borne noise sensor system, namely as a function of the detected structure-borne noise. For example, micromechanically manufactured acceleration sensors may be used for this purpose, which are also able to detect the structure-borne noise, which is between one and 50 kilohertz, for example. The structure-borne noise is the high-frequency oscillations of the vehicle structure. Structure-borne noise is generated in that the vehicle structure is influenced in a plastic or elastic manner. Instead of acceleration sensors, other sensors such as knock sensors may be used for the detection of structure-borne noise.

The crash type is the different impact types, such as front, side, angle, or rear impact, for example, but also predefined crash types such as the above-mentioned AZT crash or ODB crash. The detection of these crash types is critical for the useful triggering of the passenger protection means. In particular, the crash type may also influence the processing of accident sensor signals for determining the crash severity. The crash severity determines to what extent, how many, and which passenger protection means are to be triggered.

The predefined time period is defined more precisely in the dependent claims. The time period starts from a characteristic signal point that is determined by the signal characteristic of a signal derived from the structure-borne noise signal, for example. The time period may also start at a predefined point in time, however; it also being possible to determine the end using a signal feature or a requirement.

As specified above, the amplitude change is a change of the amplitude of a signal derived from the structure-borne noise signal, in the predefined time period. It has already been explained above that the different crash types differ to a great extent and clearly, in particular with regard to the drop of the amplitude.

In the case at hand, a control device is an electric device that processes sensor signals such as the structure-borne noise signal and brings about the triggering of the passenger protection means as a function of the processing result.

The interface may be designed as hardware and/or software. In particular, the interface may be designed such that a plurality of structure-borne noise signals are provided. In a hardware design, it is possible for the interface to be part of a so-called system ASIC. However, it may also be manufactured as a separate integrated circuit or out of discrete components or combinations of them. In a software design, in particular it is possible for the interface to be a software module on a processor. In the case at hand, in particular the design as a software module on a microcontroller is possible.

The evaluation circuit is normally a processor having one or a plurality of central processing units. In particular, a microcontroller may be used as a processor type. However, instead of a processor, an ASIC or another circuit that does not operate in a software-based manner, may also be used.

The crash type determination module, the triggering module, and the analysis module may also correspondingly be designed as hardware and/or software.

The triggering circuit may also be a part of the above-mentioned system ASIC. The triggering circuit has a corresponding logic for processing the triggering signal, which specifies whether, when, and which passenger protection means are to be triggered. Additional components of the triggering circuit are, for example, electrically controllable power switches, to connect the corresponding triggering energy to the passenger protection means.

In this context, it is advantageous that an operation signal is determined as a function of the change in amplitude and this operation signal is compared to at least one first threshold for the crash type recognition, a flag being set as a function of this comparison. This flag then indicates whether a specific crash type was detected. This operation signal is used to determine the crash type using the threshold value comparison with the first threshold. In this context, in particular two thresholds may be used in order to determine whether the operation signal is between these two thresholds in a specific time period. This is useful for the identification of the so-called ODB crash, in particular. In the case at hand, this is performed by the analysis module, which is part of the crash determination module, in the control device. The analysis module has a threshold value decider that compares the at least one threshold to the operation signal. The flag is set as a function thereof, in order to thus signal the crash type recognition. The flag is finally set by the crash type detection module.

Moreover, it is advantageous that a triggering characteristic in a main algorithm is set as a function of a state of this flag. This main algorithm, which processes accident sensor signals such as acceleration signals, for example, uses at least one triggering characteristic in order to determine, with the aid of a characteristic comparison with the processing signals, whether the passenger protection means are to be triggered or not. The crash type recognition influences this triggering characteristic, in that it is modified by an offset, for example. The main algorithm is a triggering algorithm, like the one known from the related art. In this context, the characteristic, which is used to evaluate the triggering, may be provided in a diagram, the speed reduction being provided on the abscissa and the acceleration being provided on the ordinate. A time-based main algorithm may also be provided, however, the triggering characteristic also being influenced in a time-dependent manner for the speed reduction. This triggering characteristic may furthermore be modified, also as a function of the accident sensor signals themselves.

It is furthermore advantageous that the crash type recognition is implemented only if a preprocessed structure-borne noise signal has exceeded a predefined second threshold. The crash type recognition is thus safeguarded in that a check is performed to see whether the structure-borne noise signal or, for example, the integrated structure-borne noise signal, is above a minimum threshold. It may also be determined whether the structure-borne noise signal is below a predefined threshold in order to ensure that the structure-borne noise signal is not much too large.

Alternatively or additionally, this safeguarding may also take place via a signal derived from the acceleration signal. This may also be implemented using the threshold value comparison. The derived signal is the acceleration signal itself, a filtered acceleration signal, an acceleration signal integrated once or twice, or processed in another manner.

The operation signal is advantageously generated in that a area is determined in the time period between a signal derived from the structure-borne noise signal and a fourth threshold. This fourth threshold is determined by the signal derived from the structure-borne noise signal itself, in that the maximum of this signal is taken and then used as the threshold. This is so because the time period is determined by the fact that it is set between the occurrence of this maximum and a predefined later point in time. This predefined later point in time is predefined by a time that must have elapsed since the maximum was reached. That is, when the maximum is reached, a counter is started, and when this counter reaches a predetermined value, the time period ends.

Furthermore, it is advantageous that the structure-borne noise signal itself or a filtered structure-borne noise signal or an integrated structure-borne noise signal is used as the signal derived from the structure-borne noise signal. In this context, the integrated structure-borne noise signal may be a window integral, in particular.

### BRIEF DESCRIPTION OF THE DRAWINGS

FIG. 1 shows a block diagram of the control device in the vehicle according to the present invention having connected components.

FIG. 2 shows a signal flow chart.

FIG. 3 shows a structure-borne noise signal time diagram.

FIG. 4 shows an additional structure-borne noise signal time diagram.

FIG. 5 shows an operation signal time diagram.

FIG. 6 shows a flow chart of the method according to the present invention.

### DETAILED DESCRIPTION OF THE INVENTION

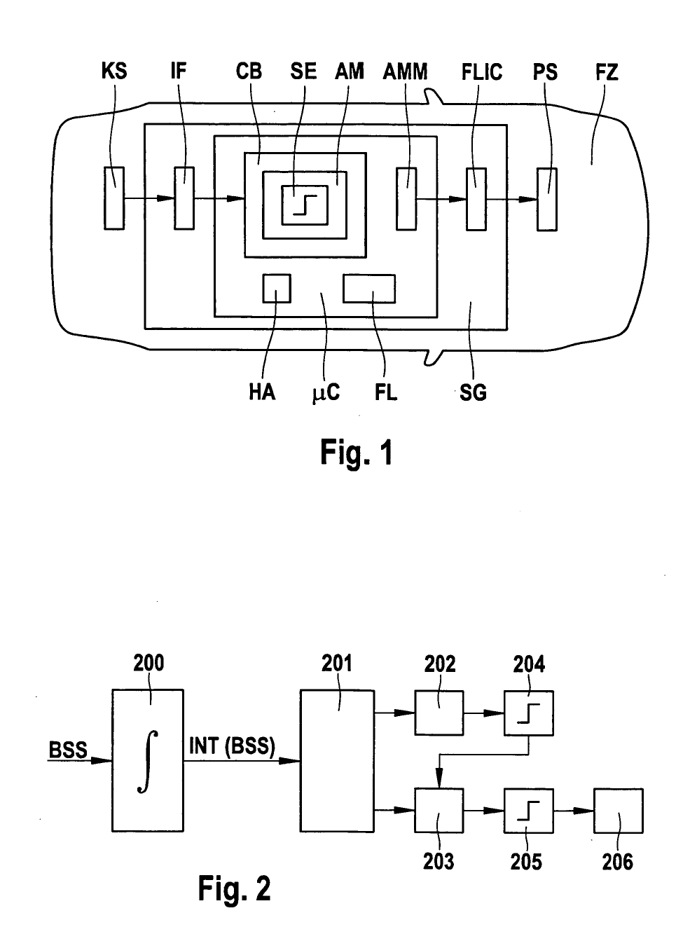

FIG. 1 illustrates in a block diagram control device SG having connected components of structure-borne noise sensor system KS and passenger protection means PS in vehicle FZ.

In the case at hand, only the components necessary to gain an understanding of the present invention are shown. Other components required for operating the control device but not contributing to an understanding of the present invention have been omitted for the sake of simplicity.

In the case at hand, structure-borne noise sensor system KS is disposed outside of control device SG and thus outside of the housing of control device SG. Structure-borne noise sensor system KS may be disposed in a sensor control device, for example. However, the structure-borne noise sensor system may also be installed in a separate housing in the vehicle, for example. Alternatively, it is also possible for the structure-borne noise sensor system to be disposed inside of control device SG. In particular, it may be provided that a plurality of structure-borne noise sensor systems are used according to the present invention.

Structure-borne noise sensor system KS is normally an acceleration sensor system in which the high-frequency signal is evaluated. In the case at hand, high-frequency means one to 50 kilohertz. Signal processing may also occur at even higher values. This acceleration sensor system is normally manufactured micromechanically, a preprocessing, for example, a measurement signal amplification, an analog-digital conversion, and possibly a filtering, additionally being assigned to the acceleration sensor system.

The signals are digitally transmitted from structure-borne noise sensor system KS to control device SG and are transmitted to interface IF there. In the case at hand, the interface is part of a system ASIC, which is designed as an integrated circuit. The task of interface IF is to convert the payload data from structure-borne noise sensor system KS along with the sensor data from the transmission format into a transmission format that is comprehensible for microcontroller pC as the evaluation circuit. A signal amplification and the like may also be provided in interface IF.

Microcontroller pC then processes these structure-borne noise signals using crash type determination module CB. In this context, the crash type determination module, in the case at hand designed as a software module, as are all other modules, uses an analysis module AM to analyze the change in amplitude of the signal derived from the structure-borne noise signal. This derivation may take place in microcontroller μC itself. However, it may also take place prior to this already, for example, through structure-borne noise sensor system KS. In the case at hand, the integrated structure-borne noise signal, in particular a window integral, is used as a derivation. This integrated structure-borne noise signal is examined in analysis module AM for the change in amplitude. To this end, the area between the integrated acceleration signal and a threshold is calculated, the threshold being determined by the maximum of the structure-borne noise signal. For example, the maximum is recognized in that a value is always specified as a maximum until it is replaced by a new value. This is implemented up to a specific time, at which the crash type analysis must set in. The area between the integrated acceleration signal and this threshold is then determined via the predefined time period, using summation, for example. In the case at hand, the predefined time period is specified in such a manner that it begins with the time of the maximum, and then a counter is counted, which counts up to a predefined value and then the time period ends. An example for this is 35 ms, the maximum having been detected at 5 ms from the contact time with the opposing party in an accident. Instead of the contact time, the exceeding of a noise threshold or the calculating back via an interpolation may be defined as the crash begin.

Accordingly, this area symbolizes the change in amplitude in the predefined time period. Thus, an operation signal exists that the threshold value decider SE compares to at least one threshold value. The output signal of this threshold value decider SE then determines which flag FL is set by crash type determination module CB. Main algorithm HA then influences its triggering characteristic with the aid of this flag. With the aid of the processing of main algorithm HA, the triggering signal is then generated by triggering module AMM and transmitted to triggering circuit FLIC.

Triggering circuit FLIC evaluates the triggering signal and triggers corresponding electric power switches, such as MOSFETs, as a function thereof, in order to supply triggering energy to the corresponding passenger protection means.

In a signal-course diagram, FIG. 2 shows how the method according to the present invention may proceed in an exemplary embodiment. Structure-borne noise signal BSS is formed into integrated acceleration signal INT (BSS) in an integrator 200, which may also be designed as a window integrator. In block 201, the maximum is sought in a specific time of this integral. If the maximum is found, then a counter 202 starts up to a predefined value 204. In parallel, in block 203, the area between a threshold value, which is specified by the maximum, and the integrated acceleration signal is determined in time characteristic INT (BSS) itself. If the counter has reached the threshold value, then area calculation 203 is ended.

The value for the area then enters into threshold value decider 205, which compares this value with a predefined threshold value. Flag 206 is set in accordance with this comparison, to indicate an AZT or an ODB crash, for example. However, instead of the area, other parameters may be determined as well, in order to determine the change in amplitude in the predefined time period.

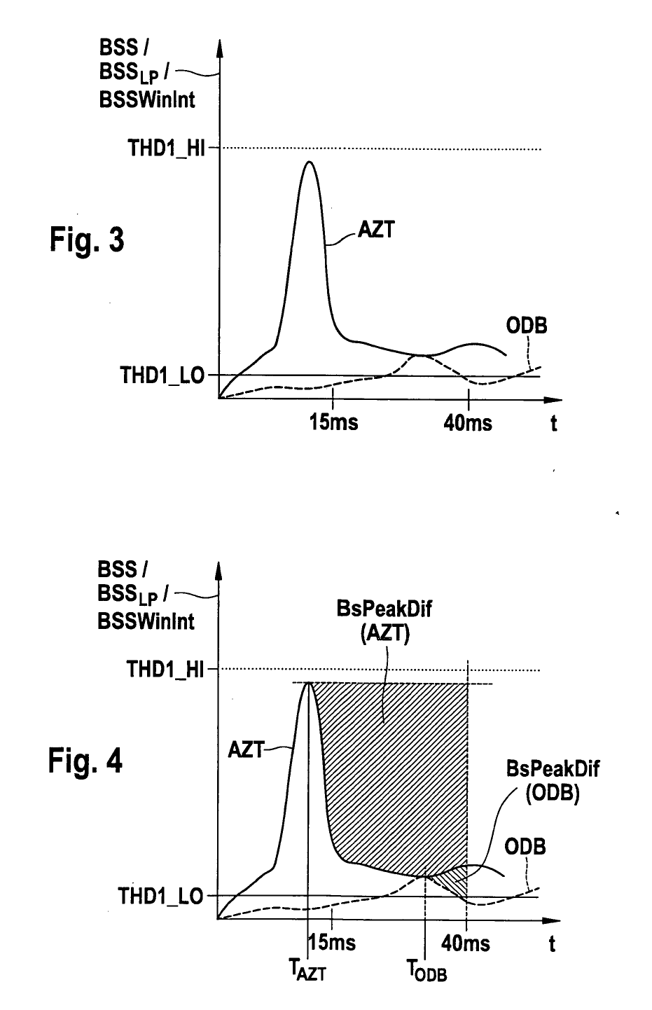

In FIG. 3, the solid line illustrates a typical progression for an AZT crash, and a dashed line symbolizes a typical progression for an ODB crash, in an integrated acceleration signal time diagram. In the case at hand, two threshold values, namely, THD1_LO and THD1_HI, are specified. The signal must at least exceed lower threshold value THD1_LO, in order for the crash type recognition to set in at all. The upper threshold value THD1_HI must remain undershot, because otherwise the crash severity is so great that a crash type recognition no longer makes sense.

It is clear that the AZT crash initially has a very high amplitude and then drops off, but still remains above the height of the so-called OBD crash. This is particularly critical, since the AZT crash normally is not a trigger crash, while the OBD crash may be a trigger crash.

FIG. 4 shows in an additional integrated structure-borne noise time diagram the same temporal progression again with threshold value THD1_LO and the AZT signal indicated by a solid line, and the ODB signal indicated by a dashed line. A new addition is the area from the point when maximum T_{AZT} is reached, and a temporal limit of 40 ms, which is specified by a counter, and T_{ODB} up to 40 ms. In these time periods, the area between the signal, for example, the solid line and the threshold, which is specified by the maximum of the signal, is calculated. In the case at hand, this area is specified by BsPeakDif (AZT) and BsPeakDif (ODB), and is described by the following equation:

$$BsPeakDif = {\sum }_{i = 1}^{k} ( max ( x ( 1 : k ) ) - x ( k )$$

It can be seen that BsPeakDif (AZT) as an operation signal is significantly greater than BsPeakDif (OBD). The operation signal BsPeakDif is calculated only if the structure-borne noise signal or the integrated structure-borne noise signal exceeds threshold THD1_LO and a corresponding flag is then set.

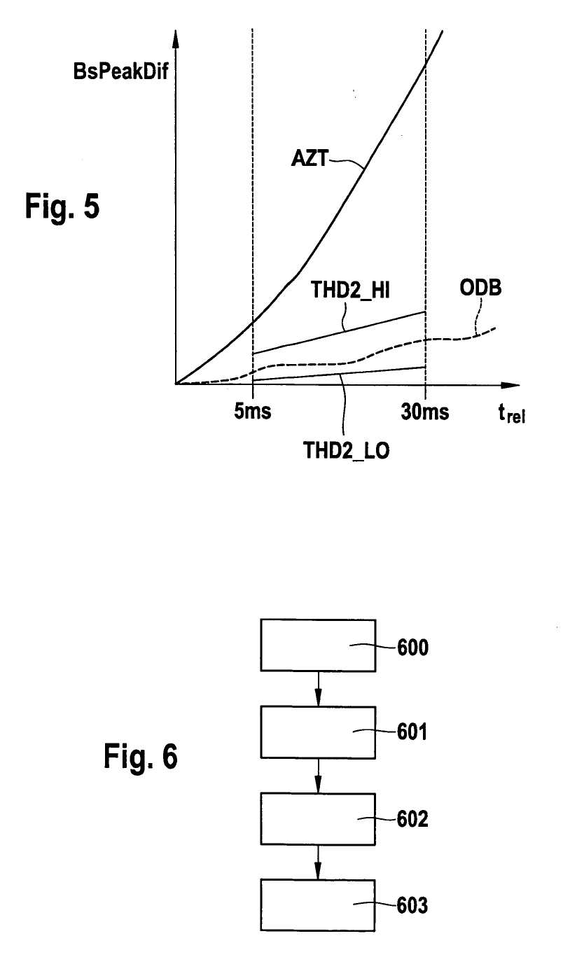

In FIG. 5, this operation signal is then compared to threshold values. In this context, a decision window of 5 to 30 ms is set on the time axis. Two threshold values, THD2_LO and THD2_HI, are used for the identification. Operation signal BsPeakDif (AZT) is much larger than both thresholds in the predefined time period, while the operation signal of the ODB crash, again illustrated in dashes, is exactly between these two threshold values, and thus the identification of the ODB crash was performed successfully.

If you compare the operation signal BsPeakDif to the thresholds THD_HI and THD_LO, which indicate the region of the change in the characteristic for the triggering characteristic in the main algorithm, then you obtain a corresponding flag. Thus, if the flag is set in an ODB40 crash, then the triggering characteristic, which in principle constitutes a contour over non-triggering cases, may be accordingly lowered by a parameterization, so that an early triggering is made possible.

As illustrated above, in order to be insensitive to non-triggering cases, additionally safeguarding conditions are checked: BSS (OBD)>THD1 and/or combined with low-frequency values of the acceleration and the speed reduction:

### A>THD3 and DV>THD4.

The upper limit THD2_HI is set as an upper limit, so that a no-fire crash, for example, bumper 8k through a higher speed, for example, does not accidentally result in a lowering of the triggering characteristic and thus allow for a faulty triggering.

FIG. 6 shows a flow diagram of the method according to the present invention. In method step 600, at least one structure-borne noise signal is provided. In method step 601, the evaluation occurs to see whether a change in amplitude exists in a predefined time period, in order to then determine the crash type in method step 602 as a function thereof. In method step 603, the triggering then takes place as a function of this crash type.

1-10. (canceled)

11. A method for triggering a passenger protection arrangement for a vehicle, comprising:
ascertaining a crash type with the aid of at least one structure-borne noise signal, wherein for the crash type ascertainment the structure-borne noise signal is evaluated in a predefined time period with regard to a change in amplitude; and
triggering the passenger protection arrangement as a function of the ascertained crash type.

12. The method as recited in claim 11, wherein an operation signal is determined as a function of the change in amplitude, and wherein the operation signal is compared to at least one first threshold value for the crash type ascertainment, and wherein a flag is set as a function of the comparison.

13. The method as recited in claim 12, wherein a triggering characteristic is set in a triggering algorithm as a function of a state of the flag.

14. The method as recited in claim 12, wherein the crash type ascertainment is implemented only if the structure-borne noise signal exceeds a predefined second threshold.

15. The method as recited in claim 12, wherein the crash type ascertainment is implemented only if at least one first signal derived from an acceleration signal exceeds at least one third threshold.

16. The method as recited in claim 12, wherein the determination of the operation signal includes determining an area in a time period between a second signal derived from the structure-borne noise signal and a fourth threshold, and wherein the fourth threshold is a maximum of the second signal, and wherein the time period is specified between the reaching of the maximum of the second signal and a predefined later time.

17. The method as recited in claim 16, wherein the second signal is one of: (i) the structure-borne noise signal; (ii) filtered signal of the structure-borne noise signal; or (iii) integrated signal of the structure-borne noise signal.

18. The method as recited in claim 17, wherein the integrated signal of the structure-borne noise signal is a window integral.

19. A control device for triggering a passenger protection arrangement for a vehicle, comprising:
an interface configured to provide at least one structure-borne noise signal;
an evaluation circuit having a crash-type determination module and a triggering module, wherein the crash-type determination module is configured to determine a crash type as a function of at least one structure-borne noise signal, the crash-type determination module having an analysis module for evaluation of a change in amplitude in a predefined time period, and wherein the triggering module is configured to generate a triggering signal as a function of the determined crash type; and
a triggering circuit for triggering the passenger protection arrangement as a function of the triggering signal.

20. The control device as recited in claim 19, wherein the analysis module has a threshold value comparator configured to compare an operation signal to at least one first threshold for the crash type determination, the operation signal being determined as a function of the change in amplitude, and wherein the crash-type determination module is configured to set a flag as a function of the comparison.
